(19) United States
(12) Patent Application Publication
(10) Pub. No.: US 2017/0126759 A1
(43) Pub. Date: May 4, 2017

(54) Systems and Methods For Capturing and Distributing News Content

(71) Applicant: EmergenSee, LLC, Malvern, PA (US)

(72) Inventors: Philip A. Reitnour, Malvern, PA (US); Sarah E. Reitnour, Malvern, PA (US); John T. Reitnour, Malvern, PA (US); Nicholas R. Reitnour, Malvern, PA (US); Benjamin F. Reitnour, Malvern, PA (US)

(21) Appl. No.: 15/342,240

(22) Filed: Nov. 3, 2016

Related U.S. Application Data
(60) Provisional application No. 62/250,185, filed on Nov. 3, 2015.

(51) Int. Cl. H04L 29/06; G06Q 30/06; H04W 4/02

(52) U.S. Cl. CPC H04L 65/4069; H04W 4/02; H04L 65/1069; G06Q 30/0613

(57) ABSTRACT

A method and system of capturing and distributing news content includes a step of receiving a communication from at least one mobile device, the communication including GPS coordinates indicating a geographic location of the at least one mobile device. The method further includes graphically displaying on a user interface an icon on a map indicating the geographic location of the at least one mobile device. Additionally, the method includes receiving at least one of video and audio data from the at least one mobile device and displaying at least a portion of the communication from the at least one mobile device on the user interface.

### CROSS-REFERENCE TO RELATED APPLICATION

This application claims benefit of U.S. Provisional Application 62/250,185, filed Nov. 3, 2015, the content of which is incorporated herein by reference.

### BACKGROUND

News media outlets frequently seek eyewitness news content related to breaking news stories to distribute to their consumers. Because of the nature of such breaking news stories and limited resources of these news media outlets, it is unfeasible for professional reporting staff to provide such eyewitness news content for all breaking news stories that require coverage. Mobile phones, such as smart phones, have similar functionality to equipment used by professional reporting staff.

### SUMMARY

The systems and methods described herein function to capture and distribute news content gathered on devices such as mobile phones. The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

In some embodiments, a method and system of capturing and distributing news content includes a step of receiving a communication from at least one mobile device, the communication including GPS coordinates indicating a geographic location of the at least one mobile device. The method and system further includes graphically displaying on a user interface an icon on a map indicating the geographic location of the at least one mobile device. Additionally, the method and system include receiving at least one of video and audio data from the at least one mobile device and displaying at least a portion of the communication from the at least one mobile device on the user interface.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

The following description is better understood when read in conjunction with the appended drawings. For purposes of illustrating the systems and methods for capturing and distributing news content disclosed herein, there is shown in the drawings exemplary embodiments thereof However, the claimed systems and methods are not limited to the specific embodiments disclosed. In the drawings:

FIGS. 1A, 1B, and 1C are schematics of an exemplary embodiment of a method and system of capturing and distributing news content;

FIG. 2 is a schematic of a portion of the exemplary embodiment of a system and method of capturing and distributing news content shown in FIGS. 1A, 1B, and 1C;

FIG. 3 is a schematic of a portion of the exemplary embodiment of a system and method of capturing and distributing news content in FIGS. 1A, 1B, 1C, and 2;

FIG. 4 is a flow diagram of a news event capture operation performed by a user's mobile device;

FIG. 5 is a block diagram of one embodiment of a computer system in which aspects of the disclosed systems and methods may be embodied;

FIG. 6 is a flow diagram of a news event capture operation performed by a monitoring system;

FIG. 7a is a flow diagram of a portion of the news event capture operation shown in FIG. 6;

FIG. 7b is a flow diagram of another portion of the news event capture operation shown in FIG. 6;

FIG. 8A is an exemplary embodiment of a user interface for a system and method of capturing and distributing news content showing locations of user-reported news events;

FIG. 8B is an exemplary embodiment of a user interface for a system and method of capturing and distributing news content showing locations of user-reported news events;

FIG. 9 is an exemplary embodiment of a user interface for a system and method of capturing and distributing news content showing numbers of reported news events in various geographical areas;

FIG. 10 is an exemplary embodiment of a user interface for a system and method of capturing and distributing news content showing locations of user-reported news events, visual data from a mobile device of a user who reported a news event, and previous locations and directions of movement of the mobile device of the user;

FIG. 11 is an exemplary embodiment of a user interface for a system and method of capturing and distributing news content showing visual data from a mobile device of a user who reported a news event;

FIG. 12 is an exemplary embodiment of a user interface for a system and method of capturing and distributing news content showing a broadcast message window;

FIG. 13 is an exemplary embodiment of a user interface for a system and method of capturing and distributing news content showing visual data received from a mobile device and an indication that a news report has been closed;

FIG. 14 is an exemplary embodiment of a user interface for a system and method of capturing and distributing news content showing closed news reports;

FIG. 15 is an exemplary embodiment of a user interface for a system and method of capturing and distributing news content showing current and previous locations and directions of movement of the mobile device of the user; and

FIG. 16 is yet another exemplary embodiment of a user interface for a system and method of capturing and distributing news content showing current and previous locations and directions of movement of the mobile device of the user.

### DETAILED DESCRIPTION OF ILLUSTRATIVE EMBODIMENTS

The various aspects of the subject matter described herein are now described with reference to the accompanying drawings, wherein like numerals refer to like or corresponding elements throughout. It should be understood, however, that the drawings and detailed description relating thereto are not intended to limit the claimed subject matter to the particular form disclosed. Rather, the intention is to cover modifications, equivalents, and alternatives falling within the spirit and scope of the claimed subject matter.

Components described below relate to a computer-related entity, either hardware, a combination of hardware and software, software, or software in execution. For example, components may be, but are not limited to being, a process running on a processor, a processor, an object, an executable instruction, a thread of execution, a program, and/or a computer. By way of illustration, both an application running on a computer and the computer can be a component. One or more components may reside within a process and/or thread of execution and a component may be localized on one computer and/or distributed between two or more computers.

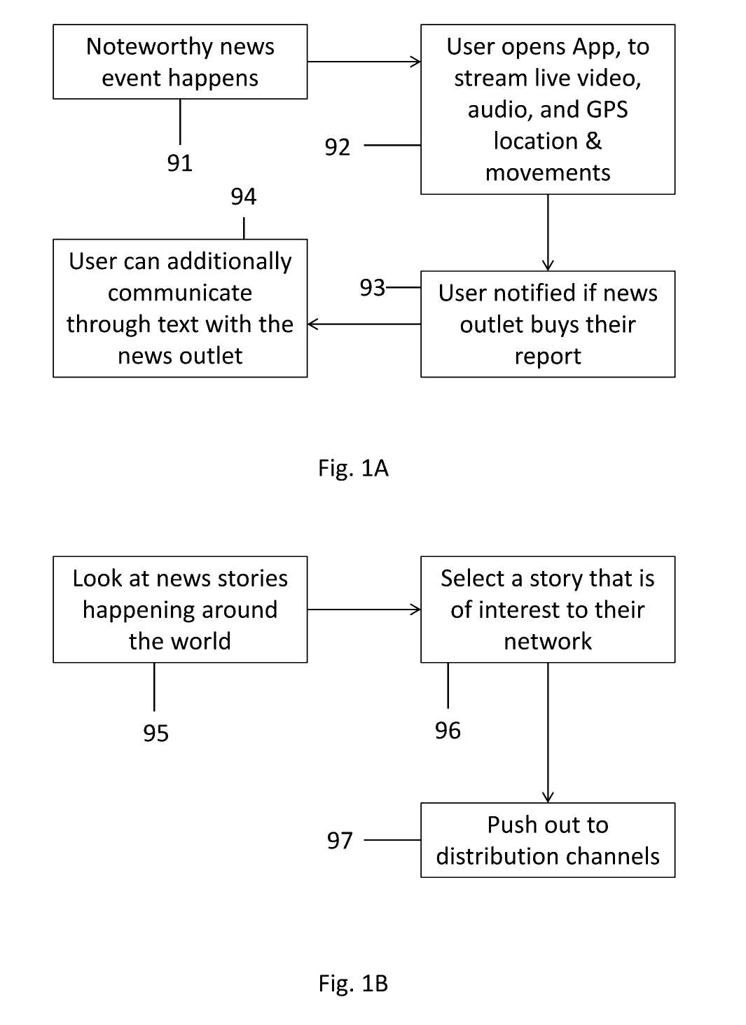

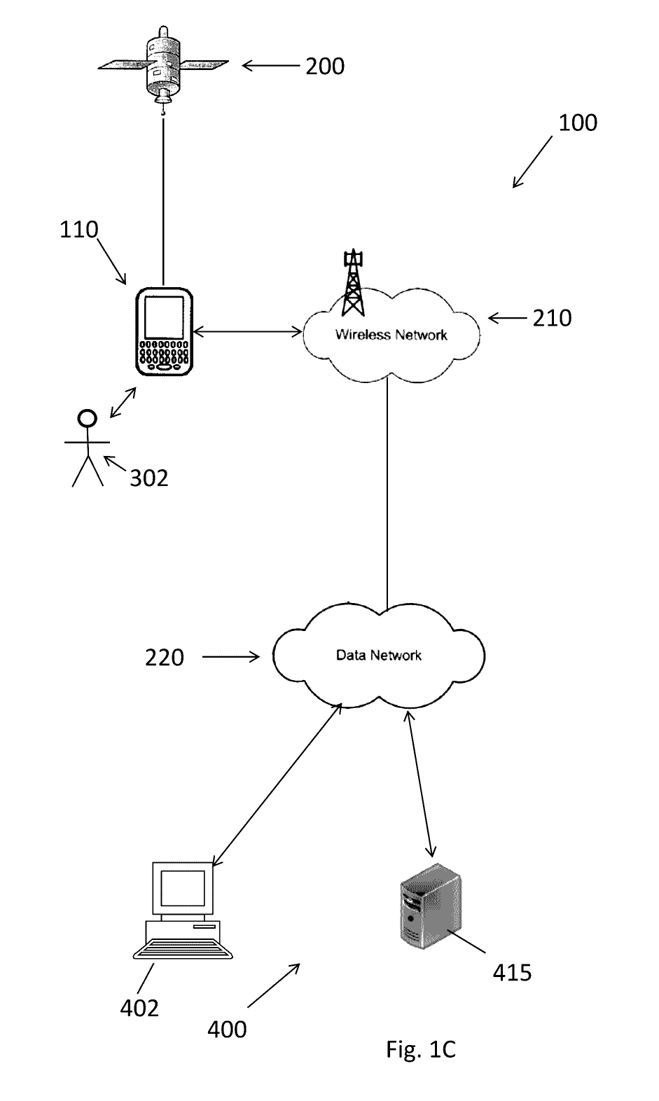

With reference to FIGS. 1A, 1B, and 1C, the following description relates to a method and system of capturing and distributing news content 100 that includes a monitoring subsystem 400 and one or more mobile devices 110. Steps 91-94 describe how a user 302 of a mobile device captures news content 100 for use by a news outlet. At step 91, a newsworthy news event occurs in the proximity of a user 302. User 302 opens an application on the user's mobile device 110 at step 92 to stream live video, audio, and GPS location and movements. At step 93, user 302 is notified if a news outlet has purchased the user's news report. After step 93, user 302 may have additional communication with the news outlet. Steps 95-97, at least a portion of which may occur concurrently with at least a portion of steps 91-94, describe how a news outlet selects and distributes news content. At step 95, the news outlet looks at news stories happening in various geographies. At step 96, the news outlet selects a news story that is of interest to the news outlet's network. At step 97, the news outlet pushes the news story out to its distribution channels.

With reference now to FIG. 1C, monitoring subsystem 400 includes at least one server 415 that captures information from the one or more mobile devices 110. Information stored on server(s) 415 is accessible via at least one computing device 402. The server(s) 415 and computing device(s) 402 may be controlled by the same or different entities. For example, an entity such as a news network may control both server(s) 415 and the computing device(s) 402 used to access the information on the server(s). Alternatively, an entity such as a news broker may control server(s) 415 and multiple other entities such as news networks may control computing devices 402 that are used to access at least parts of the information on server(s) 415.

Each mobile device 110 is configured to capture information relating to a news event and may comprise any suitable device, examples of which include a portable computing device, such as a tablet or laptop, a personal digital assistant (“PDA”), a portable phone (e.g., a cell phone or the like, a smart phone, a video phone), a portable email device, or a combination thereof. Device 110 may be a wireless device that includes a position location system 112, such as a GPS receiver that uses the wireless device's antenna to receive signals from a multiplicity of GPS satellites and process those signals to determine its position therefrom, a camera 114, such as a digital video and/or still camera, a microphone 116, a speaker 118, and a keyboard 120 (either physical or electronically displayed on a touch screen).

The position location system 112 works in conjunction with GPS satellites 200 that comprise any group of satellites that transmit GPS downlinks used for positioning by a GPS receiver of the position location system 112. Each satellite has a computer, a clock, and a radio on board, and continually broadcasts its changing position and time. The GPS receiver is housed within or is coupled to the wireless mobile device and triangulates its own position by processing the signals from downlinks from three or more satellites, resulting in a longitude and latitude position. In some GPS receivers, timing information that is derived from the processing of the received GPS signals from downlinks is provided over a cellular (or other wireless link) to a remote entity which in turn computes the position of the GPS receiver. Such systems are sometimes called Assisted GPS receivers (AGPS). The position location system described herein could include either conventional and/or AGPS receivers, as well as other position location devices and methods.

Device 110 includes a wireless telecommunication system that is designed to transmit and receive data 108 between the device 110 and wireless network 210, such as cellular base stations, WiFi hubs, etc. Any conventional telecommunication system can be used in the invention for communicating data 108.

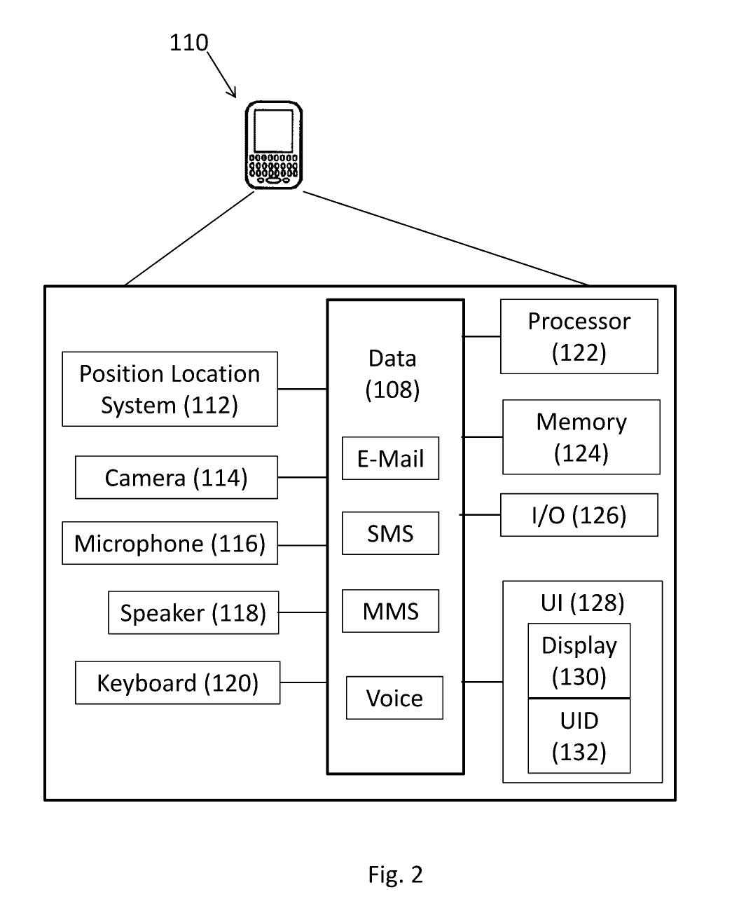

With reference to FIG. 2, device 110 further comprises a processor 122, a memory 124, an input/output interface 126, and a user interface 128 that includes a display 130, which may display the user interface graphically, and a user input device 132. The processor 122, memory 124, the input/output interface 126, and the user interface 128 cooperate to allow communications therebetween. In various embodiments, the input/output interface 126 comprises a receiver of the computing device, a transmitter of the computing device, or a combination thereof. The input/output interface 126 is capable of sending and receiving information over a network such as, for example, the Internet.

The user interface 128 of device 110 can provide the ability to control the device 110, via, for example, buttons, soft keys, voice actuated controls, a touch screen, movement of the device 110, visual cues (e.g., moving a hand in front of a camera on the device 110), or the like. The device user interface 128 can provide visual information (e.g., via display 130), audio information (e.g., via speaker 118), mechanically (e.g., via a vibrating mechanism), or a combination thereof The device user interface 128 can comprise means for inputting biometric information, such as, for example, fingerprint information, retinal information, voice information, and/or facial characteristic information. The device 110, such as a smart phone or tablet, may also communicate with an application store via a network such as, for example, the Internet. The application store may be, for example, a company specific store or an open device specific store.

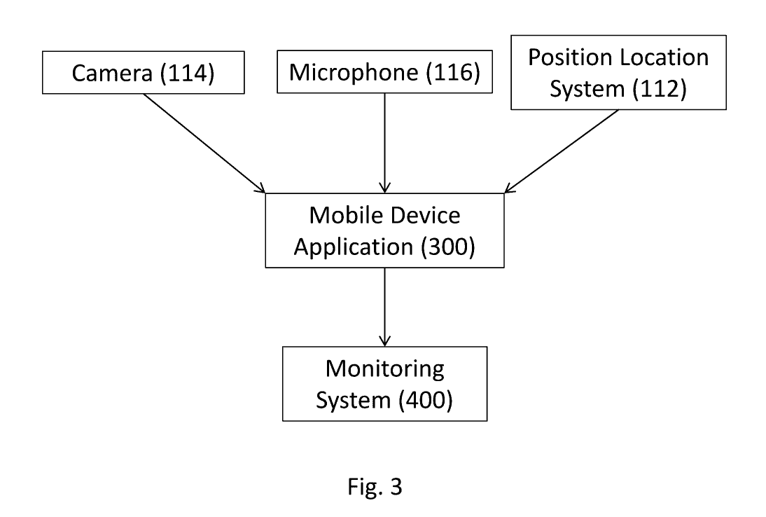

With reference to FIG. 3, the system 100 includes a mobile device application 300, which is installed on the mobile device 110. The mobile device application 300 may comprise computer-executable instructions, or program code, stored on a non-transitory computer readable storage medium within the mobile device. The computer-executable instructions of the mobile device application 300, when executed by the processor 122 of the mobile device, cause the mobile device 110 to perform various information capture functions described more fully below. The application 300 may be loaded onto the device 110 either through a wired or wireless connection, such as via a download from a remote storage location, like a server hosting a site with multiple applications (e.g., the Apple App Store), that are downloaded by a user 302. The application 300 may be available to user 302 for free, or for a purchase fee. Alternatively, user 302 may pay for use of the application 300 on a recurring basis. For example, a user 302 may pay to use the application 300 for a period of time, such as a month. Alternatively, a user 302 may pay per use to use the application 300.

Application 300 uses device 110 to communicate with the monitoring subsystem 400 via the wireless network 210 and the data network 220. The wireless network 210 may be any wireless network, such as a wireless network operated by a mobile network operator (e.g., AT&T™, Sprint™, T-Mobile™, etc.). The data network 220 may comprise any public or private data network, including the Internet or an intranet.

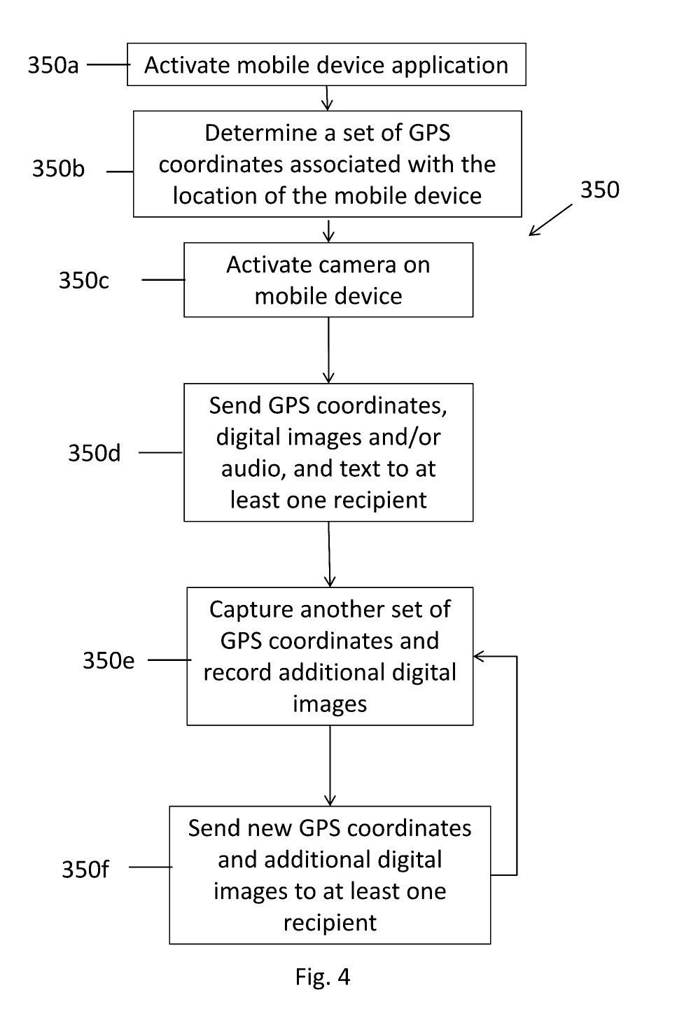

FIG. 4 is a flow diagram illustrating a news event capture operation 350 of the mobile application 300 in accordance with one embodiment thereof. At step 350a, when a user 302 seeks to report on a news event, the user 302 activates the application on the user's mobile device 110. Upon activation, the mobile application 300 is configured to perform some or all of the following steps automatically, i.e., without further user input. Alternatively, some or all of these steps may be performed at the direction of the user 302. First, at step 350b, the mobile device 110 resolves a set of GPS coordinates associated with the location of the mobile device. At step 350c, the mobile application activates a camera 114 on the mobile device 110 to record digital image(s) and/or audio of the news event over a period of time. Digital images may include both video and still images. At step 350d, the mobile application sends a message from the mobile device 110 to the monitoring subsystem 400 via data network 220. The message may include the GPS coordinates of the mobile device 110 determined at step 350b, the digital image(s) and/or audio recorded at step 350c, and/or text, such as a description relating to the GPS coordinates and the digital image(s) and/or audio that are associated with the news event. The user 302 may enter the description to be sent to the data network 220 after activating the mobile application. Alternatively, the description may be preset before the user 302 activates the mobile application.

At step 350e, after a predetermined period of time, the mobile application captures another set of GPS coordinates associated with the current location of the mobile device 110 and records additional digital images and/or audio of the news event over a period of time. At step 350f, the mobile application sends the new GPS coordinates and the additional digital images and/or audio from the mobile device 110 to the monitoring subsystem 400 via data network 220. Steps 350e and 350f are then repeated such that updated GPS coordinates and additional digital images and/or audio of the news event are sent to the monitoring subsystem 400 via data network 220.

In one embodiment, the monitoring subsystem 400 comprises a server application (referred to herein also as a “monitoring application”) running on one or more computer servers 415 (shown in FIG. 1), also referred to herein as a “monitoring server.” The server application may be implemented in accordance with any of a variety of different server architectures, such as via one or a combination of network-based hosted services, cloud services, Software as a Service (SaaS), Communications as a Service (CaaS), virtual services, on-demand services, public switched telephone network (PSTN) services or the like.

In one embodiment, entities such as news networks, desiring to monitor certain mobile devices 110 can establish an account with the monitoring subsystem 400 which provides such entities with web browser-based access to the services and functions provided by the monitoring server application of the monitoring subsystem 400. Once an account is established, monitoring personnel associated with the entity can direct a web browser running on a computing device 402 of the entity to the URL of the monitoring server 415 or its monitoring application. The computing device 402 may be any suitable computing device, such as a desktop computer, laptop computer, tablet, mobile device, or the like, which includes a web browser and is capable of communicating via the data network 220. As mentioned above, in some embodiments, the same entity —such as a news network—may operate and control both the monitoring server(s) 415 and the computing device(s) 402.

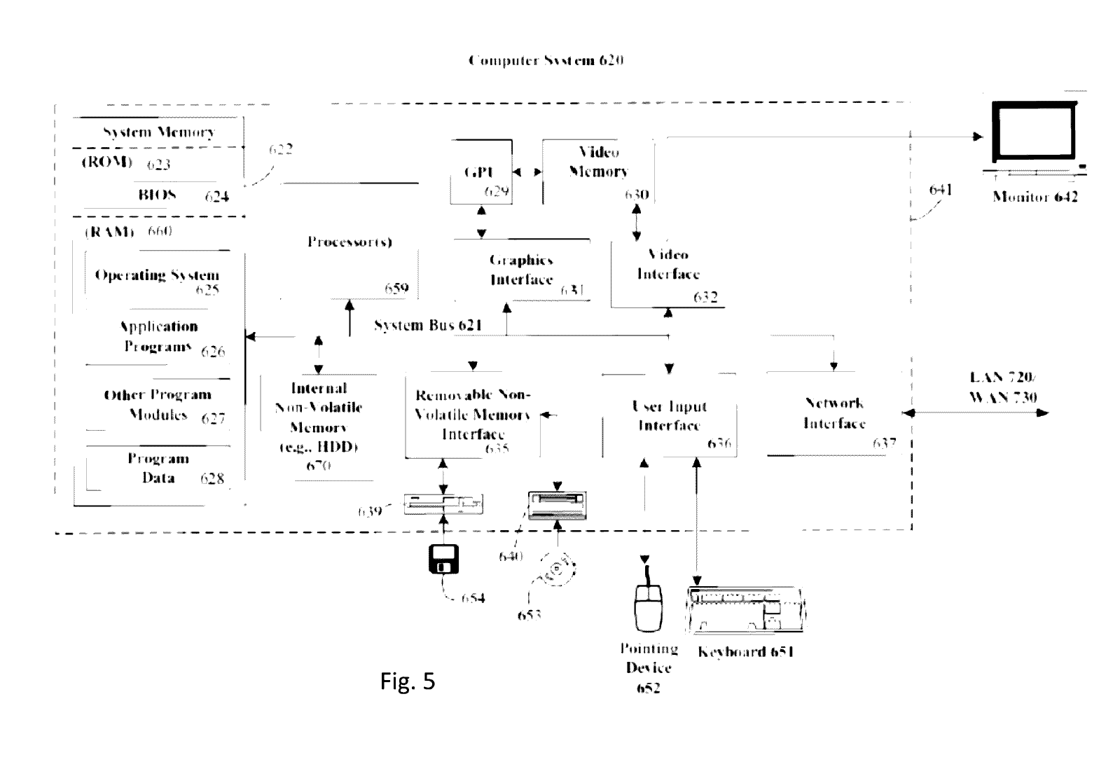

Referring now to FIG. 5, a block diagram of an example computer system 620 on which the embodiments described herein and/or various components thereof may be implemented is shown. For example, each of the server(s) 415 that host the monitoring application of the monitoring subsystem, the computing device 402 of the entity having an account on the monitoring subsystem 400, and even one of the mobile devices 110, may be implemented by the example computer system 620 of FIG. 4. It is understood, however, that the computer system 620 is just one example of a suitable computing environment and is not intended to suggest any limitation as to the scope of use or functionality of the presently disclosed subject matter. Neither should the computer system 620 be interpreted as having any dependency or requirement relating to any one or combination of components illustrated in FIG. 5. In some embodiments, the various depicted computing elements may include modules or components configured to instantiate specific aspects of the present disclosure.

For example, the components used in this description may include specialized hardware components configured to perform function(s) by firmware or switches. In other example embodiments, components may include a general purpose processor, memory, etc., configured by software instructions that embody logic operable to perform function(s). In example embodiments where modules or components include a combination of hardware and software, an implementer may write source code embodying logic and the source code may be compiled into machine readable code that can be processed by the general purpose processor. Since the state of the art has evolved to a point where there is little difference between hardware, software, or a combination of hardware/software, the selection of hardware versus software to effectuate specific functions is a design choice left to an implementer. More specifically, a software process may be transformed into an equivalent hardware structure, and a hardware structure may itself be transformed into an equivalent software process. Thus, the selection of a hardware implementation versus a software implementation is one of design choice and left to the implementer.

In FIG. 5, the computer system 620 comprises a computer 641, which may include a variety of computer readable media. Computer readable media may be available media that may be accessed by computer 641 and may include volatile and/or nonvolatile media, removable and/or non-removable media. The system memory 622 may include computer storage media in the form of volatile and/or nonvolatile memory such as read only memory (ROM) 623 and random access memory (RAM) 660. A basic input/output system 624 (BIOS), containing the basic routines that help to transfer information between elements within computer 641, such as during start-up, may be stored in ROM 623. RAM 660 may contain data and/or program modules that are immediately accessible to and/or presently being operated on by processing unit 659. By way of example, and not limitation, FIG. 4 illustrates operating system 625, application programs 626, other program modules 627, and program data 628. As a further example, video content (e.g. video frames) and/or metadata (e.g. closed caption data), in one embodiment, may be stored in the system memory 622, as well as in any of a variety of non-volatile memory media discussed herein.

The computer 641 may also include other removable/non-removable, volatile/nonvolatile computer storage media. By way of example, the computer 641 may include a hard disk drive 670 that reads from or writes to non-removable, nonvolatile magnetic media, a magnetic disk drive 639 that reads from or writes to a removable, nonvolatile magnetic disk 654, and an optical disk drive 640 that reads from or writes to a removable, nonvolatile optical disk 653 such as a CD ROM or other optical media. Other removable/non-removable, volatile/nonvolatile computer storage media that can be used in the exemplary operating environment include, but are not limited to, magnetic tape cassettes, solid-state drives, flash memory cards, digital versatile disks, digital video tape, solid state RAM, solid state ROM, and the like. Magnetic disk drive 639 and optical disk drive 640 may be connected to the system bus 621 by a removable memory interface, such as interface 635. The drives and their associated computer storage media discussed herein, and illustrated in FIG. 5, may provide storage of computer readable instructions, data structures, program modules and other data for the computer 641. As used herein, the terms “computer-readable medium” and “computer-readable storage medium” refer to physical, non-transitory storage media and do not encompass transitory media, such as signals.

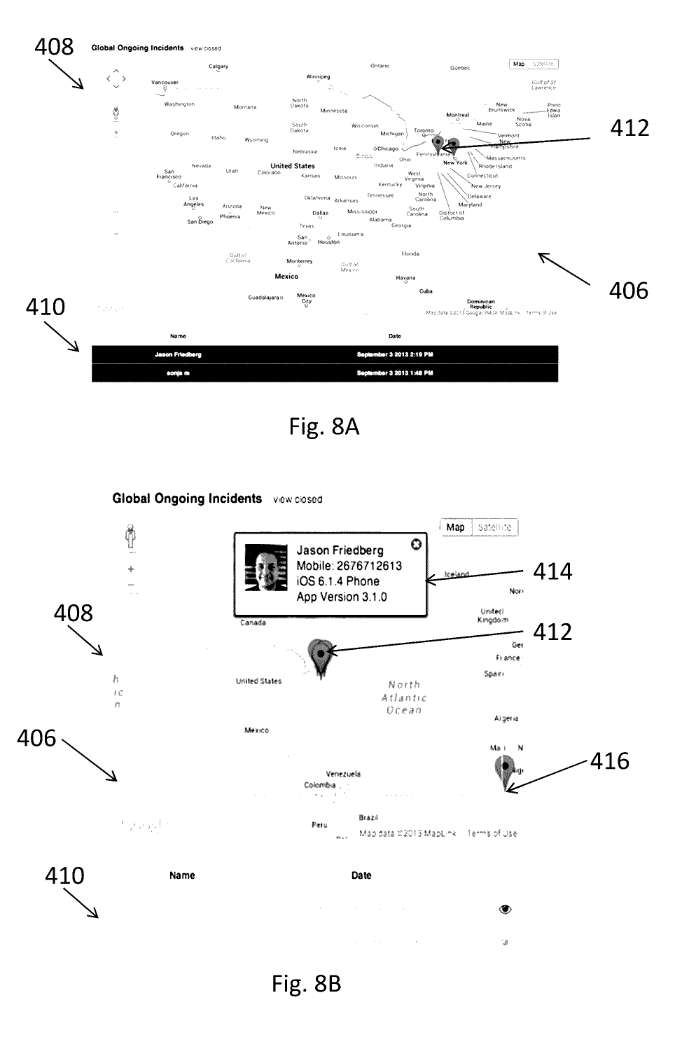

A user may enter commands and information into the computer 641 through input devices such as a keyboard 651 and/or pointing device 652, commonly referred to as a mouse, trackball, or touch pad. Other input devices (not shown) may include a microphone, joystick, game pad, satellite dish, scanner, or the like. These and other input devices may be connected to the processing unit 659 through a user 302 input interface 636 that is coupled to the system bus, but may be connected by other interface and/or bus structures, such as a parallel port, game port, or a universal serial bus (USB) for example. The computer may connect to a local area network or wide area network, such as LAN 720 and/or WAN 730, through a network interface or adapter 637. For example, the computer 641 may connect to the wireless network 210 and/or the data network 220 of FIG. 1C. A monitor 642 connects to the computer system 620 and may be used to display the various screens of graphical user interface 401, such as the graphical user interface screens shown in FIGS. 8A-16.

As is apparent from the embodiments described herein, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., computer executable instructions). This program code may be stored on a computer-readable storage medium, such as the various computer-readable storage media described above, wherein, when the program code is loaded into and executed by a machine, such as a computer or server, the machine becomes an apparatus for practicing the invention. The program code may be implemented in a high level procedural or object oriented programming language. Alternatively, the program code may be implemented in an assembly or machine language. In any case, the language may be a compiled or interpreted language. When implemented on a general-purpose processor, the program code may combine with the processor to provide a unique apparatus that operates analogously to specific logic circuits.

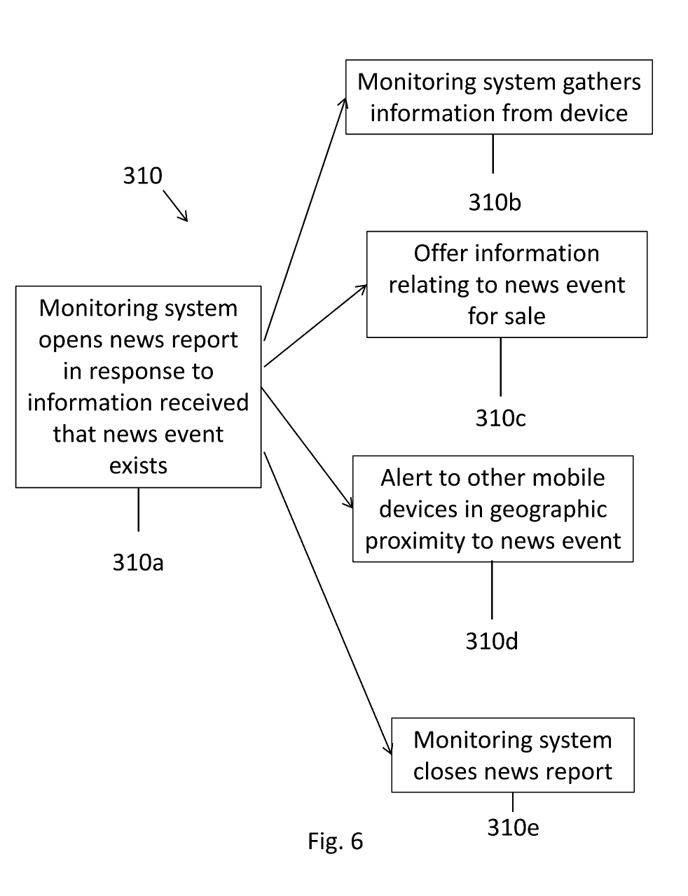

With reference now to FIG. 6, steps performed by the monitoring subsystem 400 are described in relation to a news event capture mode 310. News event capture mode 310 is configured to respond to a reported news event in a multitude of ways. One, some, or all of these ways may be employed automatically and/or at the direction of an operator of the monitoring subsystem 400. The monitoring subsystem 400 may receive information from the mobile device application 300 running on device 110, indicating that a news event has occurred and sending a news report creation request to the monitoring server 415.

At step 310a, the monitoring server 415 then creates an object in memory representing a news event report with data associated with the news event. Once the server 415 creates the object in memory, monitoring system 400 begins to gather information associated with the news event report from the device 110 at step 310b. Some or all of this information may be accessible to entities such as news networks during step 310c, before, during, or after information gathered in step 310b is offered for sale. Additionally, at step 310d, the monitoring application on server 415 may alert other mobile devices 110 in geographic proximity to the reported news event so that other mobile devices 110 can capture other news event reports associated with the news event. Lastly, once it is determined that no additional information will be added to the news event report, the monitoring system 400 closes the report.

With reference again to step 310a, when news event capture mode is initiated by creating an object in memory, the application 300 on the device 110 begins sending periodic communications to the monitoring subsystem 400, including aspects of the news report that include information concerning the location of the mobile device 110 (e.g., GPS coordinates determined by the position location system 112), video or images captured by the camera 114 of the mobile device, and/or audio captured by the microphone 116 of the device, as described in relation to the news event capture operation 350. Some or all of this news report may be accessible to entities such as news networks before, during, and after step 310c when this information is offered for sale through the graphical user interface 401.

FIGS. 8A and 8B show views, or screens, of the graphical user interface 401 presented by the monitoring subsystem 400 to monitoring personnel of entities such as news networks operating the web browser of a computing device 402. In these views, different sized maps 406 are presented in a first window 408 of the interface 401. When a communication is received from the mobile device application 300 running on a user's mobile device 110, resulting in the monitoring subsystem 400 opening a news report for that communication, the news report is listed in a second window 410 of the graphical user interface 401, along with any other news reports that have been opened. In addition, an icon, such as pinpoint 412, is displayed on the map showing the location of the reported news events, as determined from position information (e.g., GPS coordinates) included in the communication from the mobile device.

As further illustrated in FIG. 8B, when monitoring personnel select one of the news reports, for example by single-clicking on the pinpoint 412 for that news report or single-clicking on the news report in the list shown in window 410, a pop-up window 414 may be displayed showing additional information about the user 302 and/or the user's device. That information may be information that was included in the communication received from the mobile device 110, or it may be information stored by the monitoring subsystem 400 in a user 302 profile created for the user 302 of the mobile device upon the user 302 registering with the monitoring subsystem 400. Such information may include biographical information about the user 302, along with a credibility rating that may be used to assess the veracity of the information related to the reported news event. The credibility rating may be based on reviews by monitoring personnel that have received previous news event reports from the user 302.

FIG. 8B also shows a default location 416. If position information is not resolvable, pinpoint 412 may appear at the default location 416. Default location 416 may be a location on the map 406 that is readily identifiable as being an erroneous location, such as an unpopulated geography.

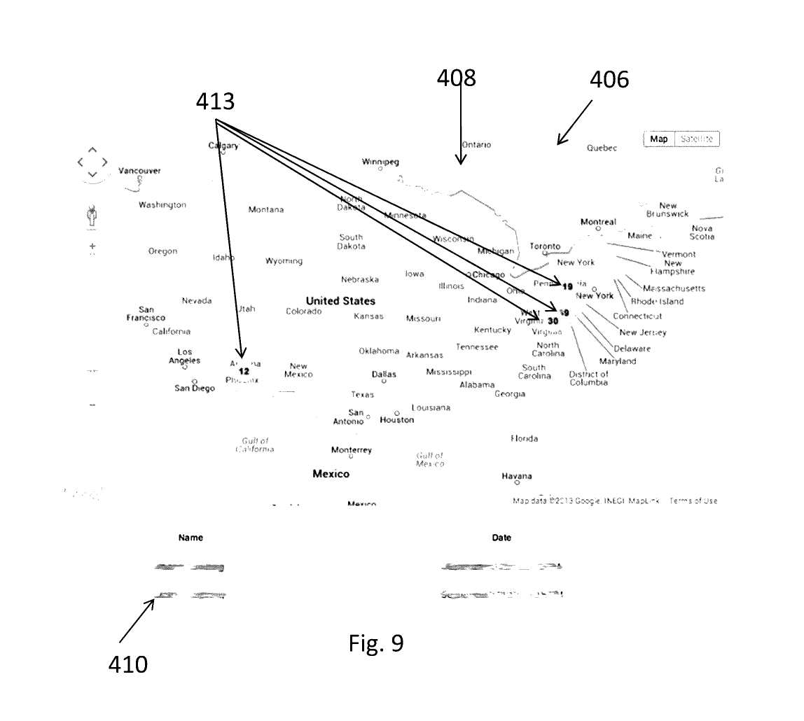

FIG. 9 illustrates another feature of the user interface 401 of monitoring subsystem 400. Specifically, when the number of news event reports opened in a given geographic area becomes too great to clearly display the individual pinpoint icons for each report, the reports may be aggregated into a single, larger icon that displays a count of the number of reports currently opened in that area. Four such larger icons are shown in this example at 413.

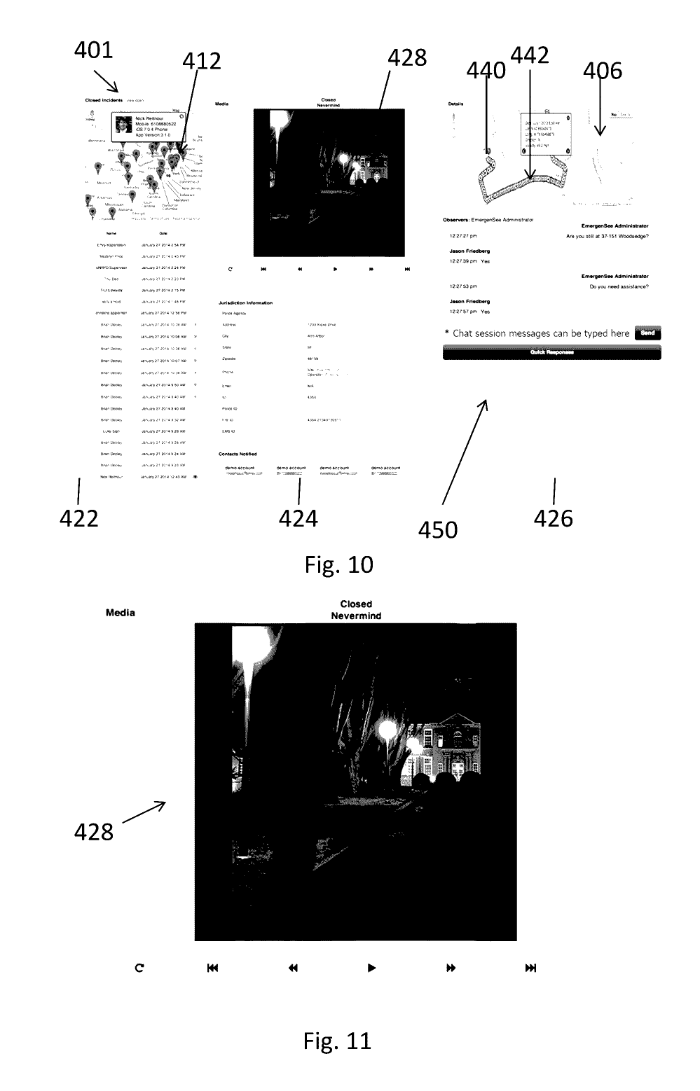

When monitoring personnel select a report from the user interface 401, such as any of the views shown in FIGS. 8A, 8B, and 9, for example by double-clicking on the pinpoint 412 or double-clicking on the report's listing in window 410, report-specific graphical user interface 401 is displayed. FIG. 10 shows one embodiment of a report-specific view of the interface 401 that may be displayed to the monitoring personnel. As shown, this view of the interface 401 comprises three panels 422, 424, and 426. The first panel 422 is a reduced view of the larger view shown in FIG. 8A, providing essentially the same information as that larger view. The monitoring personnel can continue to interact with the pinpoints 412 and report listing shown in panel 422, in the same manner as can be done using the views of interface 401 shown in FIGS. 8A, 8B, and 9. The second panel 424 provides a media viewer that displays any video or still images included in the communication(s) received from the mobile device 110 for that report. As the monitoring subsystem 400 receives data, when monitoring personnel select the news report, information received from the device 110 is shown. For example, with reference to FIGS. 10 and 11, a live video stream 428 from a camera 114 on the device may be displayed. The interface 401 may provide for replay, rewind, pause, and fast forward capabilities. Prior to purchase at step 310c, panel 424 may be partially or fully restricted from view from monitoring personnel such that only a portion or none of the video or still images are displayed. The third panel 426 displays a detailed map 406 and pinpoint 412 of the location included in the communication from the mobile device 110. The third panel 426 also presents a text messaging interface 450 that the monitoring personnel can use to communicate with the user 302 of the mobile device 110 via text messaging. The monitoring application running on server 415 may prompt the reporter 101 with general and/or specific questions about the breaking news story. Prior to purchase at step 310c, panel 426 may also be partially or fully restricted from view from monitoring personnel.

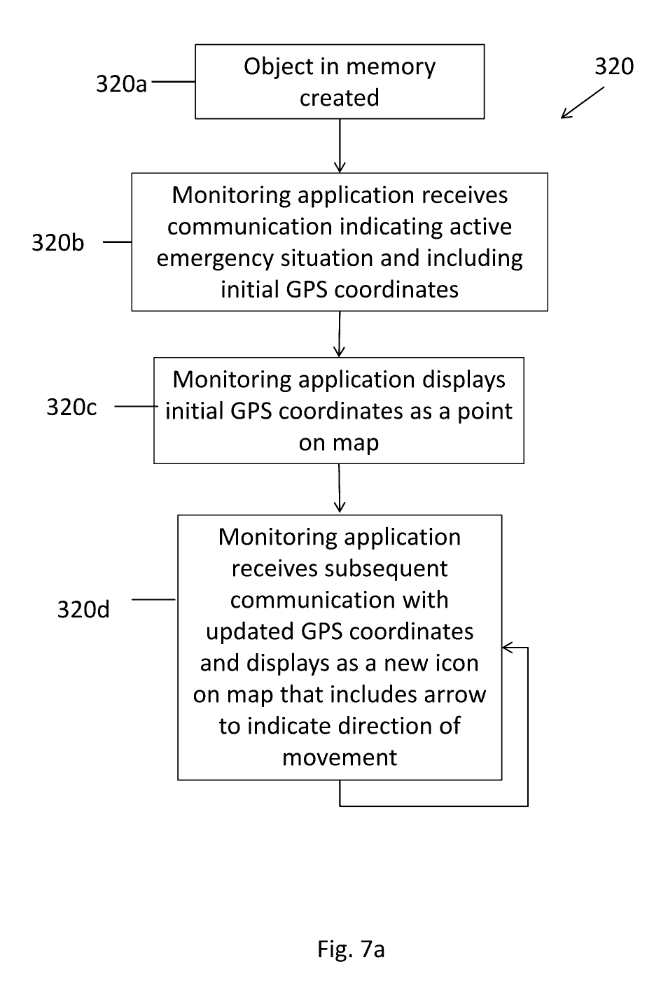

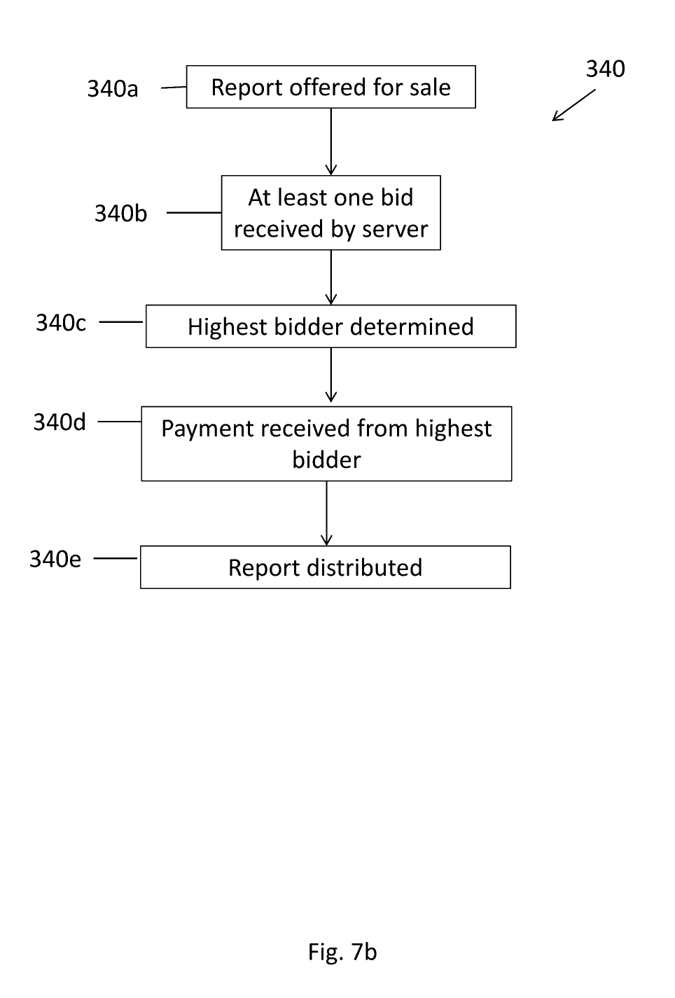

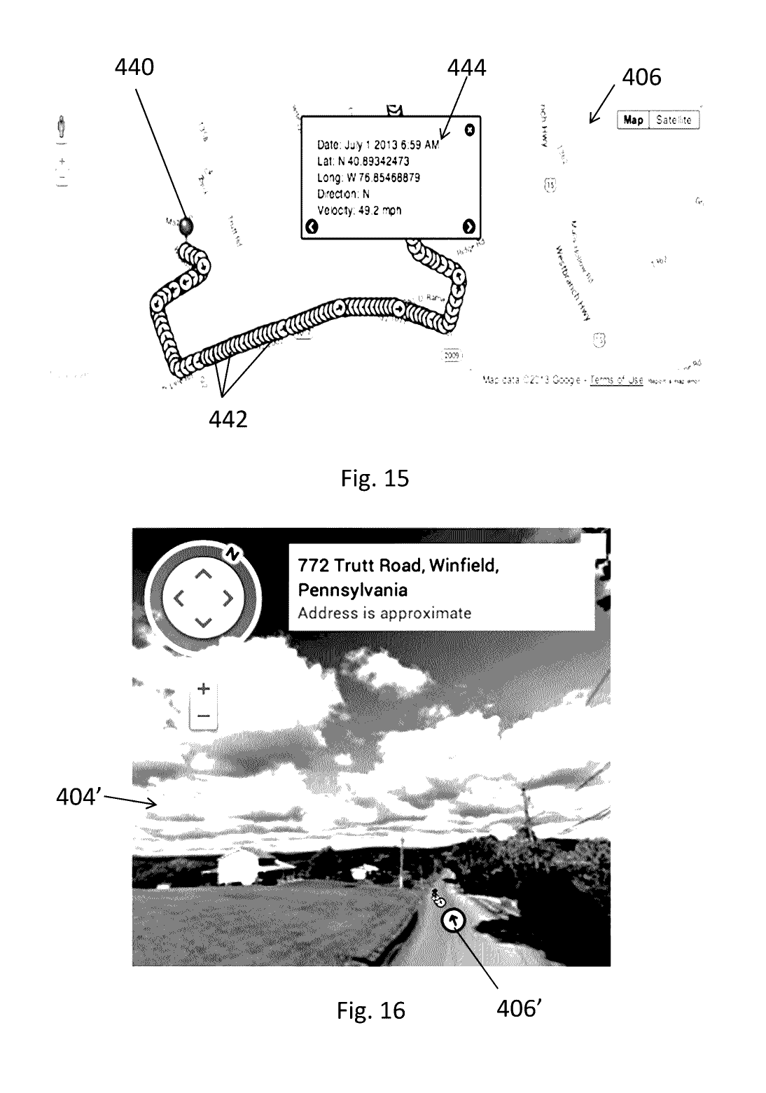

Information displayed in panels 422, 424, and 426 is updated for each report according to a tracking mode 320 described in relation to FIG. 7a. After the tracking mode 320 is initiated at step 310a when a user 302 activates the application 300 on the user's mobile device 110 and server 415 creates an object in memory representing the news event report, device 110 sends a communication to monitoring subsystem 400 that includes an initial set of GPS coordinates for the device 110. At step 320b, the monitoring application of the monitoring subsystem 400 receives this communication. At step 320c, the monitoring application may then display these initial GPS coordinates as a first point 440 on the map 406 displayed in the third panel 426 of the view of the user interface 401 shown in FIG. 10. FIG. 15 show enlarged views of the map 406 of FIG. 10. The first point 440 may be displayed in multiple ways. For example, first point 440 may be displayed as a pinpoint or as a dot.

As described above, the mobile application executing on the device 110 automatically and periodically sends subsequent communications to the monitoring subsystem 400, each including updated GPS coordinates of the device. At step 320d, the monitoring subsystem 400 receives these communications and displays the subsequent GPS coordinates as subsequent points 442 on the map 406. In one embodiment, the subsequent points 442 are each displayed as a circular icon on the map that includes an arrow indicating a direction of movement of the device determined from the particular GPS coordinates represented by that icon. The direction of movement of the mobile device at each tracked point on the map may be determined by the device 110, the monitoring subsystem 400, or both. For example, the monitoring subsystem 400 may calculate direction of movement based on the most recent GPS data and the second most recent GPS data. The monitoring application on server 415 calculates direction using the changes in latitude and longitude to calculate the degree of an arc from the previous location to the current location. The server also calculates velocity using distance travelled per unit time. Step 320d continues to iteratively repeat as long as the mobile application on the device 110 remains active or the news report is otherwise closed.

In some embodiments, tracking mode 320 may further include displaying speed of movement on the user interface 401. Like determining direction of movement, speed of movement may be determined by the device 110, the monitoring subsystem 400, or both. For example, the monitoring subsystem 400 may calculate speed of movement based on the most recent GPS data and the second most recent GPS data. Speed of movement for each subsequent point 442 may be shown, for example, in a pop-up window 444 on map 406, as shown in FIG. 15.

With reference to FIG. 16, the first point (not shown) and subsequent points 408′ for a tracked mobile device may be shown on a three-dimensional map, such as a street view map 406′. The interface 401 shown in FIG. 10 may be modified such that third panel 426 shows the street view map 406′ instead of map 406.

The graphical user interface 401 may include a purchase/distribution interface that allows monitoring personnel to purchase information in the news report at step 310b. The user interface may be configured to offer some or all of the news report for sale in multiple ways. In one embodiment, all of the information sent from device 110 is available to monitoring personnel prior to purchase. In other embodiments, only a portion of the information sent from device 110, such as still images and/or a text description of the news event, is available prior to purchase. In still other embodiments, only the GPS coordinates associated with the mobile device 110 are accessible prior to purchase.

For example, if a user 302 of mobile device 110 is witnessing a political speech, the information available for monitoring personnel prior to purchase may include a real-time photograph of the politician and a short written description that includes the politician's name and the topic of the speech. The written description may alternatively or additionally include a pre-set tag to categorize the news report. Monitoring personnel may confirm the veracity of the report based on a rating of the user 302 of the device 110, as described above, as well as based on the set of GPS coordinates included in the description. In other embodiments, information available prior to purchase may be more or less detailed. For example, the description may include only a pre-set tag and a selling price. The news content description may also include at least one time stamp of the information included in the report.

The purchase/distribution interface may be configured to provide the monitoring personnel with additional information about the news report. For example, the purchase/distribution interface may have functionality for keyword searching that scans tags and text descriptions of different news reports received by the server 415. Additionally, monitoring personnel may be able to search for news reports via map 406. Specifically, monitoring personnel interested in any news report related to a specific geography can search that geography using map 406 to see if any news reports have been posted to the server 415 in a given period of time. For example, monitoring personnel may search the map 406 for a particular city, using a parameter such as “Past Two Hours” to view any news reports with time stamps within the past two hours of the search. Alternatively or additionally, the parameter such as “Past Two Hours” may provide search results for any news reports posted to the server 415 within the past two hours of the search

Provided that there are multiple entities seeking access to news reports, the purchase/distribution interface may further be configured to provide differing levels of information to different groups. In one example, a group of “premium” level entities may have access to all news reports with full text searching functionality. A group of “basic” level entities may only be able to see some news reports and/or may or may not have text searching functionality.

In another example, an entity may have exclusive access to news reports of certain mobile device users 302. For example, a group of mobile device users 302 may be affiliated with a particular news network that receives news reports from those users 302 exclusively and without needing to purchase such reports. Fees associated with this service may be based on the number of mobile device users 302 and/or the data size of the news reports.

Purchase price for news reports may be fixed, determined via a bidding process, or both. For example, users 302 may sign up to report for a certain news outlet and offer news reports to that news outlet when events occur. If the news outlet selects a given user's report, then the news outlet pays the user for that report. In another example, user interface 401 may be configured to offer for sale all news reports at the same fixed price. Alternatively, prices may be fixed based on at least one of a variety of factors such as type of content, quality of content, geography of the device 110, and/or geography of the device 110 in relation to current events. More specifically, news reports comprising a high quality video may be valued higher than news reports comprising only a low resolution digital photograph. Similarly, news reports derived from a device 110 located in a major metropolitan area with a large news-following public during a planned event may be valued higher than news reports derived from a device 110 located in a rural area where no planned events were expected to occur.

The monitoring application on server 415 may be configured to determine the selling price for news reports based on a timed bidding process. For example, for a two to five minute time period after server 415 receives the news report, monitoring personnel will have the opportunity to submit a bid. The purchase/distribution interface may or may not display the highest bid in real-time. At the end of the time period, the highest bidder will be sent the news report, and/or full access to information from the device 110 in exchange for the bid price.

Alternatively, the user 302 of the device 110 may have the option to value the news report and the first bidder to enter a bid above that value will be sent the news report in exchange for the bid price. If the monitoring application on server 415 is configured to determine the selling price for news report based on a bidding process, the monitoring application on server 415 may be further configured to offer the news report for sale at a fixed price after a certain period of time if no bids are received or any bids received are not at a sufficient value.

As described above, the news network that purchases the news report may receive the ability to contact the user 302 of the device 110 via the text message within interface 401. The purchasing news network may also receive contact information for the user 302 of the device 110 in order to be able to speak with the user 302 in person using device 110. Alternatively, the monitoring application on server 415 may directly and/or automatically contact the device user 302 for the purchasing network via text or telephone functionality on the device 110. Contacting the user 302 may provide the network with additional eyewitness information not otherwise included in the news report. The monitoring application and the mobile application on the device may also be capable of establishing an in-app voice call to enable the monitoring personnel and the user of the mobile device to engage in a voice conversation concerning the news report. For example, the voice call can be used to engage in an interview of the mobile device user about a particular news event being recorded by the user's device. All or portions of the voice call can be recorded by the monitoring personnel to provide further audio—for later playback—in connection with the particular news event.

In an exemplary embodiment described in relation to FIG. 7b, at least one entity is provided with access to the news report, including GPS coordinates, and at least one of video and audio data using selling process 340. As step 340a, the report is offered for sale through user interface 401. At step 340b, at least one bid is received by server 415. At step 340c, the monitoring application on server 415 determined the highest bidder based on the at least one bid received. At step 340d, the server receives payment from the highest bidder. At step 340e, the news report is distributed to the highest bidder.

Once payment is received from the purchasing entity and the news report is distributed, the server may be further configured to distribute at least a portion of the payment received to the user 302 of the device 110. For example, the user 302 may receive 5-50% of the purchase price of the news report. Alternatively, the user 302 may receive 100% of the purchase price, but the user 302 may be charged for the use of the device application on an ongoing basis (such as monthly or per use). User 302 may also receive compensation based on the number of views a given news content entry has.

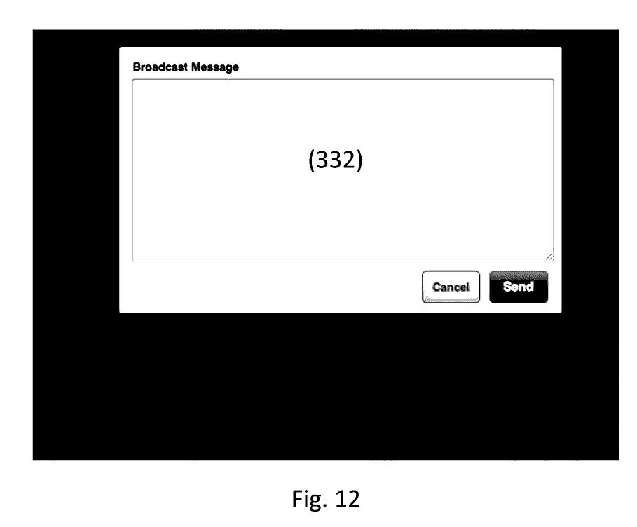

Referring again to FIG. 6, optionally, at step 310d monitoring subsystem 400 may send a broadcast alert to other mobile devices 110 in geographic proximity to the news event (i.e., the location indicated in the communication received from the mobile device for which the news report was opened). With reference to FIG. 12, the monitoring application may present a pop-up window 332 to enable monitoring personnel to enter text of a broadcast message. After entering the text, the monitoring personnel may press “Send” to cause the message to be broadcast. For example, the monitoring personnel may use this feature to send out a broadcast message to invite other users 302 to capture the news event.

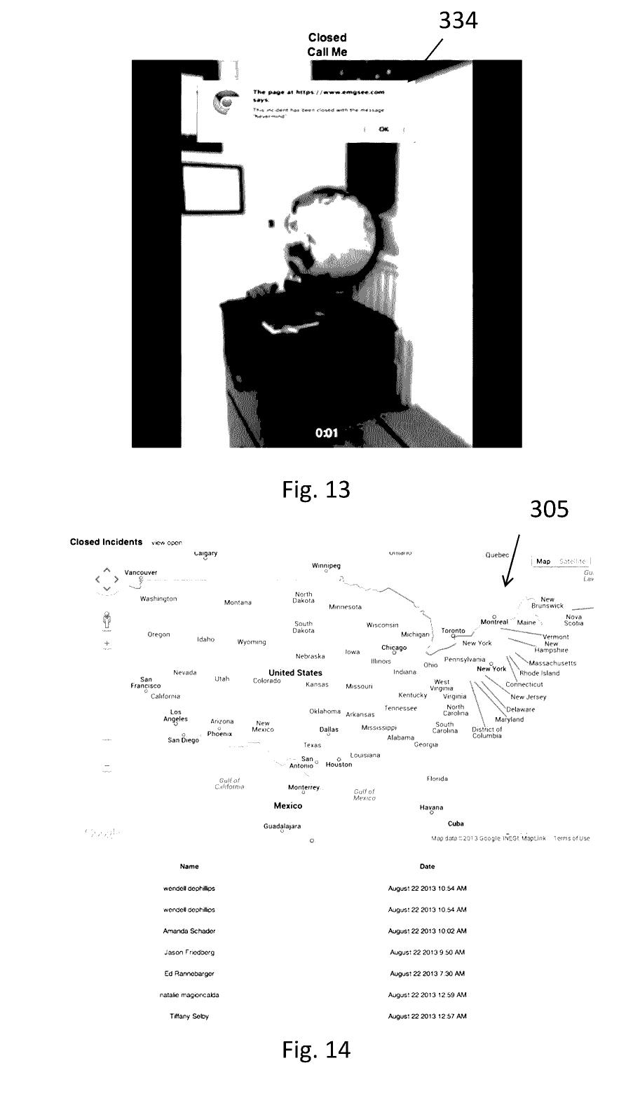

With reference to FIGS. 13 and 14, alternatively, or in addition to the steps described above, if monitoring subsystem 400 determines that a news report should be closed, the news report is closed at step 310e. For example, with reference to FIG. 13, if, after a news report has been opened, the user 302 indicates that he accidently reported that a news event exists, monitoring subsystem 400 will close the news report and an icon 334 indicating the news report is closed will appear on the user interface 401. With reference to FIG. 14 closed news reports may be listed in part of the user interface 401.

In addition to the ways described above, a news report may also be closed if no data has been received from the device for at least 60 minutes. When a news report is closed, the news report's status is updated in the monitoring subsystem 400.

As the foregoing illustrates, the present invention is directed to systems and methods of capturing and distributing news content. Changes may be made to the embodiments described above without departing from the broad inventive concepts thereof Accordingly, the present invention is not limited to the particular embodiments disclosed, but is intended to cover all modifications that are within the spirit and scope of the invention as defined by the appended claims.

What is claimed:

1. A method of capturing and distributing news content, the method comprising:
receiving a communication from at least one mobile device, the communication including GPS coordinates indicating a geographic location of the at least one mobile device;
graphically displaying on a user interface an icon on a map indicating the geographic location of the at least one mobile device;
receiving at least one of video and audio data from the at least one mobile device; and
displaying at least a portion of the communication from the at least one mobile device on the user interface.

2. The method of claim 1, further comprising a step of offering for sale the communication from the at least one mobile device to at least one third party.

3. The method of claim 2, further comprising steps of:
receiving payment for purchase of the communication from the at least one mobile device from the at least one third party; and
distributing the communication from the at least one mobile device to the one of the at least one third party.

4. The method of claim 2, wherein the step of offering for sale to the at least one third party includes offering an opportunity to the at least one third party to bid on the communication from the at least one mobile device, and the method further includes:
receiving at least one bid from the at least one third party;
determining a highest bidder based on the at least one bid received;
receiving a payment from the highest bidder; and
distributing the communication from the at least one mobile device to the highest bidder.

5. The method of claim 2, further comprising steps of:
receiving payment from one of the at least one third party for purchase of the communication from the at least one mobile device; and
distributing at least a portion of the payment to a user of the at least one mobile device.

6. The method of claim 1 further comprising a step of providing at least one third party with contact information of a user of the at least one mobile device.

7. The method of claim 1, further comprising a step of connecting at least one third party with a user of the at least one mobile device via the at least one mobile device.

8. The method of claim 1, wherein the step of graphically displaying includes graphically displaying to at least one third party on the user interface the icon on the map indicating the geographic location of the at least one mobile device, the map depicting a region surrounding the set of GPS coordinates.

9. The method of claim 1, further comprising a step of creating a text description of the news event.

10. The method of claim 9, further comprising a step of displaying the text description to at least one third party.

11. The method of claim 1, further comprising a step of creating a tag categorizing the news content.

12. The method of claim 11, further comprising a step of displaying the tag to at least one third party.
